(19) United States
(12) Patent Application Publication
(10) Pub. No.: US 2002/0174258 A1
(43) Pub. Date: Nov. 21, 2002

(54) System and method for providing non-blocking shared structures

(76) Inventors: Michele Zampetti Dale, Quakertown, PA (US); Ryan Scott Holmqvist, Basking Ridge, NJ (US); Farrukh Amjad Latif, Lansdale, PA (US)

Correspondence Address: HITT GAINES & BOISBRUN P.C., P.O. BOX 832570, RICHARDSON, TX, 75083, US

(21) Appl. No.: 09/860,931

(22) Filed: May 18, 2001

(51) Int. Cl. G06F 9/46; G06F 15/167

(52) U.S. Cl. 709/312; 709/213

(57) ABSTRACT

Systems and methods for providing for non-blocking shared structures. In one embodiment, the system includes: (1) a plurality of interconnected functional blocks that cooperate to process communications data, (2) a shared structure, coupled to the plurality of functional blocks, that contains a plurality of shared structures for containing the communications data and (3) an intermediate buffer, coupled to the shared structure, that allows the plurality of functional blocks to write the communications data to the plurality of buffers upon demand and considers requests by one of the plurality of functional blocks to read the communications data from one of the plurality of buffers. In one embodiment, data in the form of a message or command is actually deposited in the intermediate buffer. Such message or command is linked to objects entered and removed in shared stucutres. The present invention is well suited for receiving and transmitting data between functional elements in a communications device and/or in a I/O processing computer.

### CROSS REFERENCE TO RELATED APPLICATIONS

This patent application is related to the following pending applications, which (i)are assigned to the same assignee as this application (ii) were filed concurrently with this application; and (iii) are incorporated herein by reference as if set forth in full below:

Attorney Docket No. TELG-0001, U.S. Application Ser. No. ______, entitled “Distributed Communication Device And Architecture For Balancing Processing Of Real-Time Communication Application” to Michele Zampetti Dale, et. al.

Attorney Docket No. TELG-0002, U.S. Application Ser. No. ______, entitled “System Interconnect With Minimal Overhead Suitable For Real-Time Applications” to Michele Zampetti Dale, et. al.

Attorney Docket No. TELG-0011, U.S. Application Ser. No. ______, entitled “Dynamic Resource Management And Allocation In A Distributed Processing Device” to Michele Zampetti Dale, et. al.

Attorney Docket No. TELG-0018, U.S. Application Ser. No. ______, entitled “System and Method for Coordinating, Distributing and Processing of Data” to Stephen Doyle Beckwith, et. al.

### TECHNICAL FIELD OF THE INVENTION

The present invention is directed, in general, to data processing and, more specifically, to a system and method for providing non-blocking shared resources.

### BACKGROUND OF THE INVENTION

Shared structures are devices that share resources between multiple executing functional devices. Examples of shared structures include, but are not necessarily limited to, memory, control units, central processors, and other globally shared resources. Normally with most globally shared structures there are multiple producers and consumers. Producers are devices that add information to a shared structure, whereas consumers are devices that extract information from a structure.

Most consumers and producers require exclusive access to a shared resource, because when two or more consumers and/or producers access a shared resource simultaneously, atomic operations may be corrupted. An “atomic operation” (i.e., a non-interruptible event) is typically any sequence of operations that if interrupted will likely contaminate the results.

Locking mechanisms or semaphores are often used, to ensure exclusive access to shared structures. So, when a consumer/producer desires to modify information in a shared structure, i.e., add/remove information, the consumer/producer must wait for permission to access the shared structure prior to modifying information. Once permission is granted to modify the shared structure, the consumer/producer performs a modifying act, then notifies the shared structure that modification is complete. At this point access to the share structure is unlocked. Now, other devices vie for their opportunity to gain access to the shared structure, prior to being locked out again.

Unfortunately, while consumers/producers are waiting for access to a shared structure, they often remain idle. This phenomena is informally referred to as “sit and spin.” This spinning is wasteful and in some situations can severely degrade the throughput of multi-processor system, such as in a distributed communications system. If one producer/consumer takes control of a shared structure and a second (or more) device processing real-time data fails to gain access to the shared structure, the real-time data can be stalled or overwritten; which is an unacceptable performance issue in a communications environment.

Accordingly, what is needed in the art is system and method to provide access to shared structures with minimal access delays and provide maximum modification throughput to consumers/producers accessing such shared structures.

### SUMMARY OF THE INVENTION

To address the above-discussed deficiencies of the prior art, the present invention provides a system and method for providing non-blocking shared structures. In one embodiment, a shared structure is able to carry out an atomic operation while multiple producers send data to the shared structure upon demand. An intermediate buffer is employed to receive the data and allow the shared structure to perform the atomic operation while temporarily storing the data sent from the producers. So the shared structure can carry out an atomic operation in due course and without interruption. Additionally, producers are not blocked from sending data to the shared structure while the atomic operation is performed. When the shared structure is able to receive additional data, it reads information from the intermediate buffer, typically in the order received, but not necessarily limited to that order.

One advantage of the aforementioned concept is that multiple producers of information to the same shared structure do not have to wait for an atomic operation to complete prior to sending more data to the shared structure. In a real-time environment, where the influx of communications data is potentially very high, this permits producers of data to carry out processing tasks in parallel without running out of memory space and overwriting received data.

Another aspect of the present invention, is that consumers of data from the shared structure may make requests for information on demand and receive the information once the shared structure grants permission to dequeue the information. The consumers of the present invention, are implemented with local queues so that they may receive requested information at any time after making a request and do not have to wait in an idle state from the time a request for information is made until the shared structure actually sends the requested information to the requesting consumer. Accordingly, consumers do not have to wait for completion of an atomic operation to continue other processing and can react to received information from the shared structure at the consumer's own pace.

In another embodiment, the device includes: (1) a plurality of interconnected functional blocks that cooperate to process communications data, (2) a memory, coupled to the plurality of functional blocks, that contains a plurality of data buffers for containing the communications data and (3) a message queue, (i.e., a set of messages that has the information about the location of a set of buffers), that allows the plurality of functional blocks to write the communications data to the plurality of buffers upon demand and considers requests by one of the plurality of functional blocks to read the communications data from one of the plurality of buffers.

The present invention therefore introduces the broad concept of allowing multiple producers to a shared structure such that any operation not requiring a response, including enqueuing operations (such as by a producer), are allowed upon demand, but dequeuing operations (such as by a consumer) from shared structures are allowed upon the granting of a request from at least one consumer. This enqueuing/dequeing (or producer/consumer) strategy improves the chances that shared structures are available as and when needed to receive communications data. It also permits consumers to react to dequeued communication information without having to wait for the information after the shared structure grants a request. For instance, the processor keeps working by processing other information it is not waiting for. In an embodiment to be illustrated and described, this strategy guarantees that the shared structure is available to devices wishing to store communications data therein. A manager of the shared structure, (e.g., TMM) services the requests as soon as the shared is available (not used by other function modules).

In one embodiment of the present invention, the plurality of functional blocks comprise a microprocessor. In a related embodiment, the plurality of functional blocks comprise a digital signal processor. Those having skill in the pertinent art will understand, however, that the present invention is not limited to a particular type or number of functional block.

In one embodiment of the present invention, the requests are contained in messages received from the one of the plurality of functional blocks. The present invention can take advantage of messaging to communicate demands and requests for buffer access. However, those having skill in the pertinent art will understand that the present invention is not limited to messaging.

In one embodiment of the present invention, the requests are limited to requests to read an entirety of the one of the plurality of buffers. In this manner, reads make most efficient use of the path interconnecting the memory and the requesting functional block. However, the present invention is not so limited in its broadest scope.

In one embodiment of the present invention, the message queue clears the one of the plurality of buffers subsequent to a read therefrom. Automatic clearing makes the buffers ready to receive further communications data and is appropriate in view of the fact that, in the illustrated embodiment, the communications data, once read, is not reread.

In one embodiment of the present invention, the communications data are selected from the group consisting of: (1) streaming data and (2) bursty data. Thus, while the present invention is appropriate for management and processing of streaming (e.g., audio and video) communications data, it is operable on all data, including bursty (computer) communications data.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

The present invention will be described with reference to the accompanying drawings, wherein:

FIG. 1 shows a multi-protocol environment that a communication device may be employed, in accordance with one embodiment of the present invention.

FIG. 2 is a block diagram of a communication device according to a an illustrative embodiment of the present invention.

FIG. 3 is a block diagram of sample hardware used in an Intelligent Protocol Engine in accordance with an illustrative embodiment of the present invention.

FIG. 4 is a block diagram showing an isolated view of a shared structure relationship between functional blocks and the Task Management Module, according to one implementation of the present invention.

### DETAILED DESCRIPTION

The following description is presented to enable a person skilled in the art to make and use the invention, and is provided in the context of a particular application and its requirements. Various modifications to the preferred embodiment will be readily apparent to those skilled in the art and the general principles defined herein may be applied to other embodiments and applications without departing from the spirit and scope of the invention. Thus, the present invention is not intended to be limited to the embodiments shown, but is to be accorded the widest scope consistent with the principles and features disclosed herein.

The preferred embodiments of the invention are now described with reference to the FIGUREs where like reference numbers indicate identical or functionally similar elements. Also in the FIGUREs, the left most digit of each reference number corresponds to the FIGURE in which the reference number is first used.

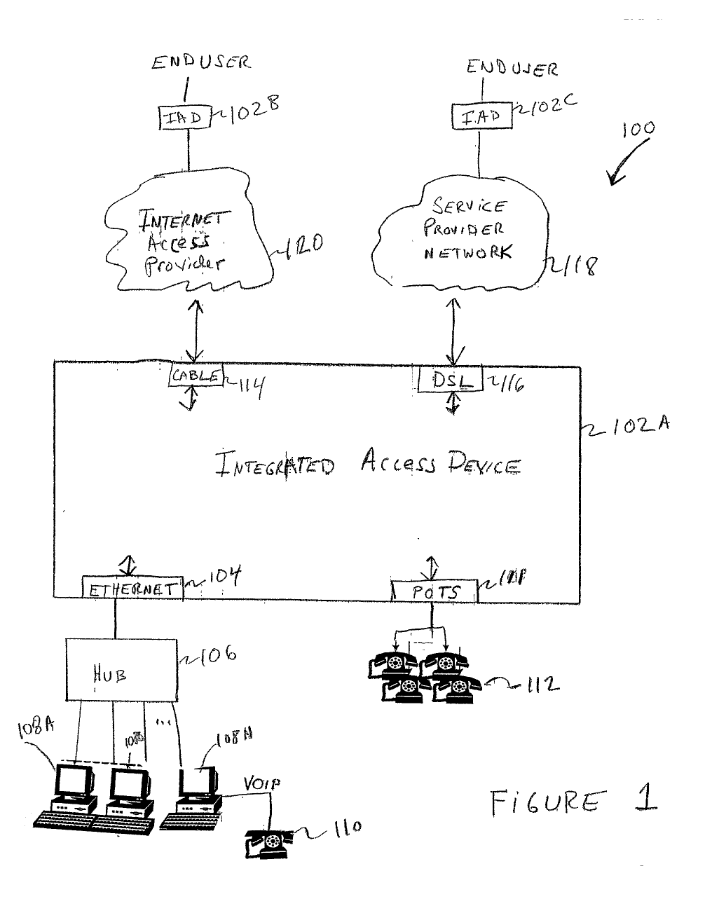

FIG. 1 shows a multi-protocol environment 100 where a communication device 102 may be employed, in accordance with one embodiment of the present invention. In this example, communication device 102 is an integrated access device (IAD) that bridges two networks. That is, IAD 102 concurrently supports voice, video and data and provides a gateway between other communication devices, such as individual computers 108, computer networks (in this example in the form of a hub 106) and/or telephones 112 and networks 118, 120. In this example, IAD 102A supports data transfer between an end user customer's site (e.g., hub 106 and telephony 112) and Internet access providers 120 or service providers' networks 118 (such as Sprint Corp., AT&T and other service providers). More specifically, IAD 102 is a customer premise equipment device supporting access to a network service provider.

Nevertheless, it is envisioned that IAD 102 may be used and reused in many different types of protocol gateway devices, because of its adaptability, programmability and efficiency in processing real-time data as well as non-real-time data.

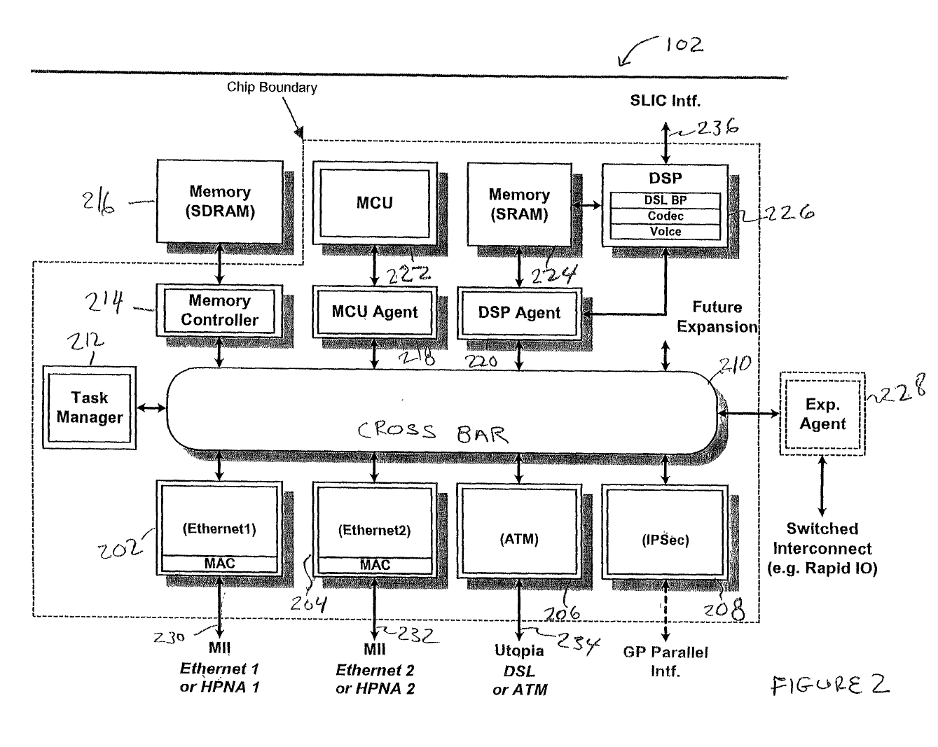

FIG. 2 is a block diagram of device 102 according to an illustrative embodiment of the present invention. Device 102 is preferably implemented on a single integrated chip to reduce cost, power and improve reliability. Device 102 includes intelligent protocol engines (IPEs) 202-208, a cross bar 210, a function allocator (also referred to as a Task Manager Module (TMM)) 212, a memory controller 214, a Micro Controller Unit (MCU) agent 218, a digital signal processor (DSP) agent 220, a MCU 222, memory 224 and a DSP 226.

External memory 216 is connected to device 102. External memory 216 is in the form of synchronized dynamic random access memory (SDRAM), but may employ any memory technology capable of use with real-time applications. Whereas, internal memory 224 is preferably in the form of static random access memory, but again any memory with fast access time may be employed. Generally, external memory 216 is unified (i.e., MCU code resides in memory 216 that is also used for data transfer) for cost sensitive applications, but local memory may be distributed throughout device 102 for performance sensitive applications such as internal memory 224. Local memory may also be provided inside functional blocks 202-208, which shall be described in more detail below. For high performance applications, the external memory can also be distributed in addition to local memory.

Also shown in FIG. 2, is an expansion port agent 228 to connect multiple devices 102 in parallel to support larger hubs. For example, in a preferred embodiment, device 102 supports 4 POTS, but can easily be expanded to handle any number of POTS such as a hub. Intelligent protocol engines 202-208, task manager 212 and other real-time communication elements such as DSP 226 may also be interchangeably referred to throughout this description as “functional blocks” and also “consumers” and/or “producers.”

Data enters and exits device 102 via lines 232-236 to ingress/egress ports in the form of IPEs 202-206 and DSP 226. For example voice data is transmitted via a subscriber line interface circuit (SLIC) line 236, most likely located at or near a customer premise site. Data, such as video, non-real-time computer data, and voice over IP, are transmitted from data devices (shown in FIG. 1 as computers 108) via lines 230 and 232. Data sent according to asynchronous transfer mode (ATM), over a digital subscriber line (DSL), flow to and from service provider's networks or the Internet via port 234 to device 102. Although not shown, device 102 could also support ingress/egress to a cable line (not shown) or any other interface.

The general operation of device 102 will be briefly described. Referring to FIG. 2, device 102 provides end-protocol gateway services by performing initial and final protocol conversion for end-user customers. Device 102 also routes data traffic between an Internet access/service provider network 118, 120, shown in FIG. 1. Referring back to FIG. 2, MCU 222 handles most call and configuration management and network administration aspects of device 102. MCU 222 also performs very low priority and control data transfer for device 102, which shall be described in more detail below. DSP 226 performs voice processing algorithms and interfaces to external voice interface devices (not shown). IPEs 202-208 perform tasks associated with specific protocol environments appurtenant to the type of data supported by device 102 as well as upper level functions associated with such environments. TMM 212 manages flow of control information by enforcing ownership rules between various functionalities performed by IPEs 202-208, MCU 222 or DSP 226.

Most data payloads are placed in memory 216 until IPE's complete their assigned tasks associated with such data payload and the payload is ready to exit the device via lines 230-236. The data payload need only be stored once from the time it is received until its destination is determined. Likewise, time critical real-time data payloads can be placed in local memory or buffer (not shown in FIG. 2) within a particular IPE for immediate egress/ingress to a destination or in memory 224 of the DSP 226, bypassing external memory 216. Most voice payloads are stored in internal memory 224 until IPEs 202-208 or DSP 226 process control overhead associated with protocol and voice processing respectively.

A cross bar 210 permits all elements to transfer data at the rate one data unit per clock cycle without bus arbitration further increasing the speed of device 102. Cross bar 210 is a switching fabric allowing point-to-point connection of all devices connected to it. Cross bar 210 also provides concurrent data transfer between pairs of devices. In a preferred embodiment, the switch fabric is a single stage (stand-alone) switch system, however, a multi-stage switch system could also be employed as a network of interconnected single-stage switch blocks. A bus structure or multiple bus structures (not shown) could also be substituted for cross bar 210, but for most real-time applications a crossbar is preferred for its speed in forwarding traffic between ingress and egress ports (e.g., 202-208, 236) of device 102. Device 102 will now be described in more detail.

MCU 222 is primarily responsible for overall system operation of device 102 and housekeeping functions. Whereas, IPEs 202-208 primarily handle specific real-time control functions associated with multiple protocol environments. This relieves MCU 222 of the burden of processing and tracking massive amounts of overhead and control information. It also permits MCU 222 to concentrate on managing optimal operation of device 102. MCU 222 primarily manages performance by handling resource management in an optimum way and initialization of call set-up/tear-down. Off-the-shelf communication processors from readily available commercial sources can be employed as MCU 222. MCU 222 is also used to reassign tasks to IPEs 202-208, in the event task manager 212 notifies MCU 222 that any one of the IPEs 202-208 are over or under utilized.

MCU 222 is connected to an MCU agent 218 that serves as an adapter for coupling MCU 222 to cross bar 210. Agent 218 makes the cross bar 210 transparent to MCU 222 so it appears to MCU 222 that it is communicating directly with other elements in device 102. As appreciated by those skilled in the art, agent 218 may be implemented with simple logic and firmware tailored to the particular commercial off-the-shelf processor selected for MCU 222.

DSP 226 may be selected from any of the off-shelf manufactures of DSPs or be custom designed. DSP 226 is designed to perform processing of voice and/or video. In the embodiment shown in FIG. 2, DSP 226 is used for voice operations. DSP agent 220 permits access to and from DSP 226 from the other elements of device 102. Like MCU agent 218, DSP agent 220 is configured to interface with the specific commercial DSP 226 selected. Those skilled in the art appreciate that agent 220 is easily designed and requires minimal switching logic to enable an interface with cross bar 210.

TMM 212 acts as a function coordinator and allocator for device 102. That is, TMM 212 tracks flow of control in device 102 and associated ownership to tasks assigned to portions of data as data progresses from one device (e.g., 202) to another device (e.g., 226).

Additionally, TMM 212 is responsible for tracking functions to be performed by devices connected to cross bar 210. TMM 212 employs queues to ensure that functionality corresponds to functional blocks. TMM 212 then notifies the device, e.g., IPE 202, that a task is ready to be transferred for IPE 202 to perform. When IPE 202 receives a notification, it downloads information associated with such tasks for processing and TMM 212 queues more information for IPE 202. As mentioned above, TMM 212 also controls the logical ownership of protocol specific information associated with data payloads, since device 102 uses shared memory. In essence this control enables TMM 212 to perform a semaphore function, but as will be described in more detail below, without the need for locking any of the functional modules whilst data flows in and out of TMM 212 and/or device 102.

IPEs 202-208 are essentially scaled-down area-efficient micro-controllers specifically designed for protocol handling and real-time speed. IPEs 202 and 204 are assigned to provide ingress/egress ports for data associated with an Ethernet protocol environment. IPE 206 serves as an ingress/egress port for data associated with an ATM protocol environment. IPE 208 performs a collection of IP security measures such as authentication of headers used to verify the validity of originating addresses in headers of every packet of a packet stream.

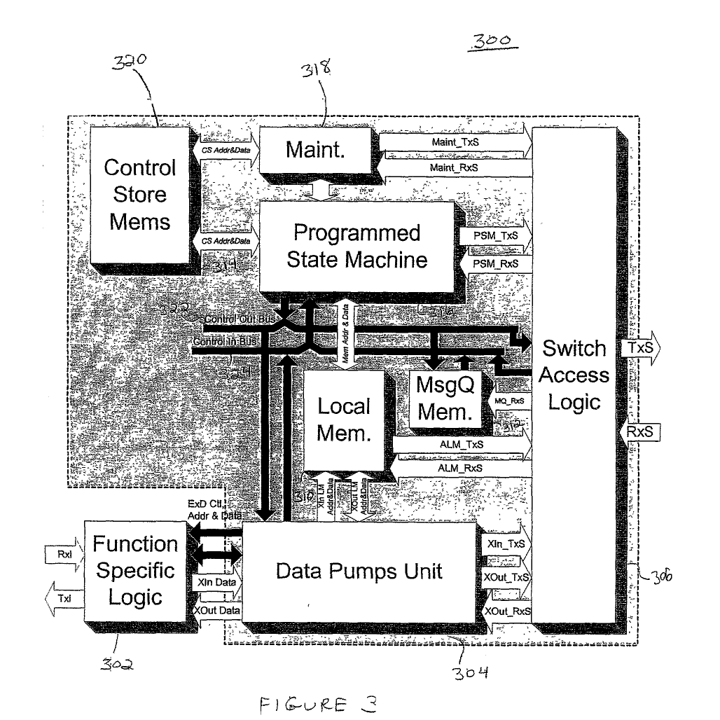

FIG. 3 is a block diagram of sample hardware used in an IPE 300 in accordance with a preferred embodiment of the present invention. Other than interface specific hardware, it is generally preferred that the hardware of IPEs remain uniform. IPE 300 includes: an interface specific logic 302, a data pump unit 304, switch access logic 306, local memory 310, a message queue memory 312, a programmed state machine 316, a maintenance block 320, and control in and out busses 322, 324. Each element of IPE 300 will be described in more detail with reference to FIG. 3. Programmed state machine 316 is essentially the brain of an IPE. It is a micro-programmed processor. IPE 300 may be configured with instruction words that employ separate fields to enable multiple operations to occur in parallel. As a result, programmed state machine 316 is able to perform more operations than traditional assembly level machines that perform only one operation at a time. Instructions are stored in control store memory 320. Programmed state machine 316 includes an arithmetic logic unit (not shown, but well known to those skilled in the art) capable of shifting and bit manipulation in addition to arithmetic operations. Programmed state machine 316 controls most of the operations throughout IPE 300 through register and flip-flop states (not shown) in IPE via Control In and Out Busses 322, 324. Busses 322, 324 in a preferred embodiment are 32 bits wide and can be utilized concurrently. It is envisioned that busses 322, 324, be any bit size necessary to accommodate the protocol environment or function to be performed in device 102. It is envisioned, however, that any specific control or bus size implementation could be different and should not be limited to the aforementioned example.

Switch access logic 306 contains state machines necessary for performing transmit and receive operations to other elements in device 102. Switch access logic 306 also contains arbitration logic that determines which requester within IPE 300 (such as programmed state machine 316 or data pump unit 304) obtains next access to cross bar 210 as well as routing required information received from cross bar 210 to appropriate elements in IPE 300. Information received from cross bar 210 is used to route the data to the appropriate requester (programmed state machine 316, data pump 304, etc.).

Maintenance block 318 is used to download firmware code that is downloaded during initialization or re-configuration of IPE 300. Such firmware code is used to program the programmed state machine 316 or debug a problem in IPE 300. Maintenance block 318 should preferably contain a command queue (not shown) and decoding logic (not shown) that allow it to perform low level maintenance operation to IPE 300. In one implementation, maintenance block 318 should also be able to function without firmware because its primary responsibility is to perform firmware download operations to control store memory 320.

In terms of memory, control store memory is primarily used to supply programmed state machine 316 with instructions. Message queue memory 312 receives asynchronous messages sent by other elements for consumption by programmed state machine 316. Local memory 310 contains parameters and temporary storage used by programmed state machine 316. Local memory 310 also provides storage for certain information (such as headers, local data and pointers to memory) for transmission by data pump unit 304.

Data pump unit 304 contains a hardware path for all data transferred to and from external interfaces. Data pump unit 304 contains separate ‘transfer out’ (Xout) and ‘transfer in’ (Xin) data pumps that operate independently from each other as a full duplex. Data pump unit 304 also contains control logic for moving data. Such control is programmed into data pump unit 304 by programmed state machine 316 so that data pump unit 304 can operate autonomously so long as programmed state machine 316 supplies data pump unit 304 with appropriate information, such as memory addresses.

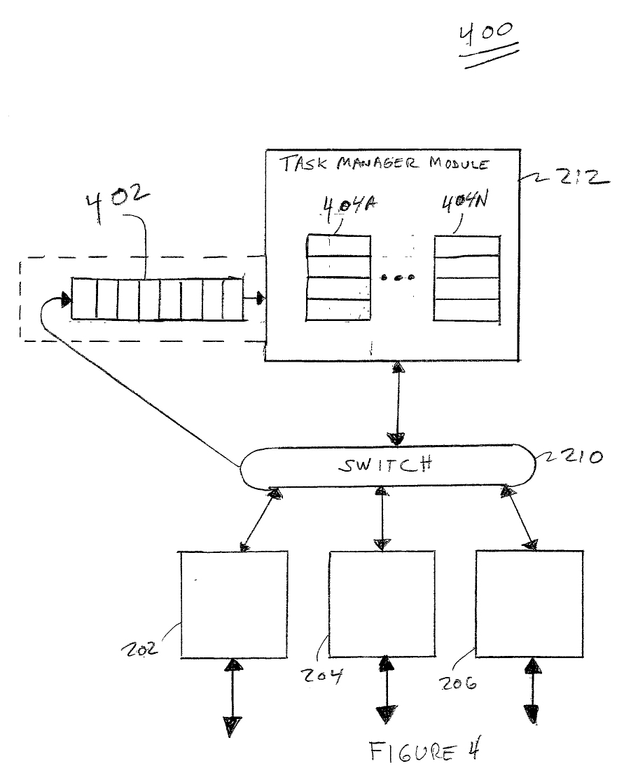

FIG. 4 is a block diagram showing an isolated view of a shared structure relationship 400 between functional blocks 202-206 and TMM 212, according to one implementation of the present invention. Referring to FIG. 4, as functional blocks 202-206 receive and transfer communications data, they may need to produce additional information for other blocks 202-206 or they may need to receive information from other functional blocks 202-206. When a functional block sends information to another functional block, the functional block is a “producer” of information. When a functional block requests information from other devices, it becomes a “consumer” of information. As used herein, information includes messages, communications data, bursty data and any other information commonly used in communication and I/o processing environments.

TMM 212 contains multiple shared queues 404 that track and allocate information to the functional blocks 202-206 whether they are producers and/or consumers. Producers enqueue (i.e., write) information into shared queues 404, whereas, consumers dequeue (i.e, read) information from shared queues 404.

To ensure that producers can send information to shared queues 404 without having to wait for permission to do so, an intermediate buffer 402 is employed in TMM 212 to receive and store intent information upon demand from producers 202-206. Such information is stored in intermediate buffer 402 and written into a queue 404 when such queue is ready to receive more information. Atomic operations performed by TMM 212 in shared queues 404, such as dequeuing operations or basic data manipulation like, shifting bits, adding, et cetera, can be performed by queues 404 without interruption, while concurrently permitting producers to send information to intermediate buffer 402. As used herein “intent information” generally refers to commands or messages, but may be more generically referred to as data.

In essence, buffer 402 serves as an intermediate buffer of intent information from functional blocks 202-206 to a shared structure, such as a queue 404A. In this embodiment, buffer 402 is a first-in-first-out register. Thus, intent information sent from the functional blocks 202-206 are stored in buffer 402 in the order received. Although it is appreciated that intent information sent from functional blocks 202-206 could be stored in other various fashions. For example, in special circumstances higher priority data may need be entered ahead of data previously stored in buffer 402 to ensure priority access to such data.

One advantage of the present invention is that buffer 402 allows functional blocks 202-206 to write (or enqueue information) directly into TMM 212 upon demand. In other words, at no time do any of the functional blocks 202-206 have to wait for the completion of atomic operations in TMM 212, prior to sending data (e.g., intent information) to buffer 402. Thus, functional devices 202-206 can continue to perform processing tasks without having to wait for a shared queues 404 to complete an atomic operation.

When functional blocks 202-206 attempt to extract information waiting in shared queues 404 in TMM 212, such functional blocks act as consumers. Each consumer typically sends a message to TMM 212 requesting to extract information. TMM 212 knows which queues 404 are associated with the requested consumer and sends information to the requesting consumer when the associated queue 404 is ready to perform an atomic operation associated with such a request.

Once a functional block 202-206 makes a request for more information, it does not have to sit idle (unless it is necessarily waiting for such information) and wait for the requested information. Instead, the requesting functional block can carry out concurrent processing tasks while its request is processed by TMM 212.

When TMM 212 is ready to send the requested information, a respective shared queue performs a dequeuing operation (i.e., read) and the intent information (i.e., a message request) is sent to the functional block which requested the information (intent information with associated information reflecting data buffers). No handshaking needs to take place between functional blocks 202-206 to receive requested information. Each functional block 202-206 is equipped with a temporary queue, shown in FIG. 3 as 312, in which requested data is queued-up and waits its turn for processing in the order of its request. Accordingly, as a consumer each functional block 202-206 operates in a reactionary mode allowing information to be extracted from shared queues 404 without having to wait and synchronize with the transfer of requested data from TMM 212.

Thus, another advantage of the illustrative embodiment, is that no locking mechanism needs to be placed on queues 404 after a read request is made from one of the functional blocks 202-206. After a read request is made, the requesting functional block 202-206 can continue to process information while it waits for the shared queue 404 to send additional information.

A controller (not shown) in TMM 212 provides a mechanism to automatically clear dequeued information from shared buffers by sending additional information from intermediate buffer 402 to push data in a stack and overwrite dequeued information. Those skilled in the art should readily appreciate how to implement simple controller to carry out the aforementioned coordination between buffer 402 and queues 404. It should also be noted that cross bar (switch 210) provides a direct path for data to travel to and from the functional blocks 202-206 and TMM 212.

Those skilled in the art should appreciate that the concepts described herein can be applied to many shared structures in accordance with the aforementioned illustrative embodiments.

Although the present invention has been described in detail, those skilled in the art should understand that they can make various changes, substitutions and alterations herein without departing from the spirit and scope of the invention in its broadest form.

What is claimed is:

1. A non-blocking system, comprising:
a shared structure for carrying out an atomic operation;
multiple producers, interconnected to said shared structure, that are capable of sending data to said shared structure upon demand; and
an intermediate buffer, configured to receive said data from said multiple producers, whereby said intermediate buffer allows said shared structure to carry out said atomic operation without interruption from said multiple producers so that said multiple producers are not blocked from sending additional data to said shared structure while an atomic operation is performed therein.

2. The non-blocking system of claim 1, wherein when said shared structure extracts data from said intermediate buffer at a time when said shared structure is ready to receive additional data.

3. The non-blocking system of claim 2, wherein said shared structure extracts said data in the order data is received by said buffer.

4. The non-blocking system of claim 1, further comprising at least one consumer of data, interconnected to said shared structure, configured to receive data from said shared structure after making a request for said data.

5. The non-blocking system of claim 4, wherein said at least one consumer includes a local queue so that said consumer may receive said requested data at any time after making a request and does not have to wait in a idle state from a time said request for data is made and a time said shared structure sends said data to said at least one consumer; whereby said at least one consumer reacts to received data from said shared structure at said consumer's own pace.

6. A communications device, comprising:
a plurality of interconnected functional blocks that cooperate to process communications data;
a memory, coupled to said plurality of functional blocks, that contains a plurality of data buffers for containing said communications data; and
a message queue, that allows said plurality of functional blocks to write said communications data to said plurality of buffers upon demand and considers requests by one of said plurality of functional blocks to read said communications data from one of said plurality of buffers.

7. The device as recited in claim 6 wherein said plurality of functional blocks comprise a microprocessor.

8. The device as recited in claim 6 wherein said plurality of functional blocks comprise a digital signal processor.

9. The device as recited in claim 6 wherein said requests are contained in messages received from said one of said plurality of functional blocks.

10. The device as recited in claim 6 wherein said requests are limited to requests to read at least a portion of an entirety of said one of said plurality of buffers.

11. The device as recited in claim 6 wherein said message queue clears said one of said plurality of buffers subsequent to a read therefrom.

12. The device as recited in claim 6 wherein said communications data are selected from the group consisting of:
streaming data, and
bursty data.

13. A method of managing communications data, comprising:
processing said communications data in a plurality of interconnected functional blocks;
providing a memory, coupled to said plurality of functional blocks, that contains a plurality of data buffers for containing said communications data;
allowing said plurality of functional blocks to write said communications data to said plurality of buffers upon demand; and
considering requests by one of said plurality of functional blocks to read said communications data from one of said plurality of buffers.

14. The method as recited in claim 13 wherein said plurality of functional blocks comprise a microprocessor.

15. The method as recited in claim 13 wherein said plurality of functional blocks comprise a digital signal processor.

16. The method as recited in claim 13 wherein said requests are contained in messages received from said one of said plurality of functional blocks.

17. The method as recited in claim 13 wherein said requests are limited to requests to read at least a portion of an entirety of said one of said plurality of buffers.

18. The method as recited in claim 13 further comprising clearing said one of said plurality of buffers subsequent to a read therefrom.

19. The method as recited in claim 13 wherein said communications data are selected from the group consisting of:
streaming data, and
bursty data.

20. A communications device, comprising:
a plurality of functional blocks, that cooperate to process communications data;
a function allocator, coupled to said plurality of functional blocks, that contains a plurality of shared structures for containing said communications data; and
a buffer, coupled to said function allocator, that allows said plurality of functional blocks to send said communications data to said plurality of shared structures upon demand while said function allocator performs one of a plurality of atomic operations to said commutations data upon demand and considers requests by one of said plurality of functional blocks to remove said communications data from one of said plurality of shared structures.

21. The device as recited in claim 20 wherein said requests are contained in messages received from said one of said plurality of functional blocks.

22. The device as recited in claim 20 wherein said requests are limited to requests to remove at least a portion of information contained in one of said one of said plurality of shared structures.

23. The device as recited in claim 20 wherein at least one of said functional blocks reacts to said buffer when notified by said buffer that a request to remove said communications data is granted.
